(19) United States
(12) Patent Application Publication
(10) Pub. No.: US 2019/0292405 A1
(43) Pub. Date: Sep. 26, 2019

(54) SLURRIES FOR CHEMICAL MECHANICAL POLISHING OF COBALT CONTAINING SUBSTRATES

(71) Applicant: FUJIMI INCORPORATED, Aichi (JP)

(72) Inventors: Hooi-Sung KIM, Tualatin, OR (US); Anne MILLER, Tualatin, OR (US)

(73) Assignee: FUJIMI INCORPORATED, Aichi (JP)

(21) Appl. No.: 15/935,379

(22) Filed: Mar. 26, 2018

(51) Int. Cl. C09G 1/02; C23F 11/10; B24B 37/04

(52) U.S. Cl. CPC C09G 1/02; B24B 37/044; C23F 11/10

(57) ABSTRACT

Provided herein are methods and compositions for chemical mechanical polishing (CMP) of a cobalt containing substrate. The present methods and compositions involve the use of a complexor, an oxidizer, an abrasive and a cobalt corrosion inhibitor including an amino acid having at least two acidic moieties. The present methods and compositions can be used to achieve a high cobalt removal rate, while effectively inhibiting corrosion during CMP.

### TECHNICAL FIELD

The present technology generally relates to chemical mechanical polishing (CMP) of metal for microelectronic applications. The present technology relates to methods and slurries that achieve a high metal removal rate, while exhibiting a great corrosion inhibition performance. The present methods and compositions are particularly useful in polishing cobalt (Co) containing substrates.

### BACKGROUND

Cobalt (Co) is a relatively new polish material for the semiconductor industry. Cobalt has been used as a promising barrier material due to its lower resistivity compared to tantalum (Ta). More recently, cobalt has been also used as a contact material or metal gate fill due to its lower resistivity relative to tungsten (W).

Chemical mechanical polishing (CMP) is an important part of damascene process flow. The chemical compositions of CMP slurries are critical to the performance of the metal CMP process. The slurries generally comprise abrasive(s) which provide mechanical abrasion action in the metal polishing, as well as chemical agents that interact with metal film surface so that the polishing removal rate and corrosion rate can be controlled.

For metal bulk polish, it is preferred to have a very high metal removal rate (RR). Meanwhile, in order to obtain a planar polished surface, it is preferred that metal corrosion is inhibited or minimized. Typically, high pH slurries limit the metal removal rate (RR), and low pH slurries cause severe corrosion of the metal during CMP. Thus, there has been substantial effort in the field toward the development of slurries at neutral or near-neutral pH, in order to achieve both high metal removal rate and good corrosion performance. Yet, conventional polishing slurries, even under neutral or near neutral pH conditions, still cause severe cobalt corrosion during CMP. Thus, there exists the need for the development of new slurries, which enable high cobalt removal rate during CMP, while effectively inhibiting cobalt corrosion.

### SUMMARY OF THE DISCLOSURE

Provided herein are compositions and methods for chemical mechanical polishing (CMP) of metals. In one aspect, provided herein is a slurry for chemical mechanical polishing (CMP) of a cobalt-containing substrate comprising a complexor, an oxidizer, an abrasive and a cobalt corrosion inhibitor, wherein the cobalt corrosion inhibitor comprises an amino acid having at least two acidic moieties.

In some embodiments, the cobalt corrosion inhibitor is selected from aspartic acid, glutamic acid, cysteine, carboxyglutamic acid, kainic acid, acromelic acid, domoic acid, alpha-aminoadipic acid, 2-amino-3-carboxymuconic semialdehyde, 2-aminomuconic acid, octopine, opine, N(ε)-carboxymethyllysine, gamma-glutamylcysteine, saccharopine, diaminopimelic acid, cystathionine, cysteinyldopa, nicotianamine, nopaline, N-methyl-D-aspartic acid, lanthionine, formiminoglutamic acid, glutathione, or derivatives or salts thereof. In some embodiments, the cobalt corrosion inhibitor is selected from aspartic acid and glutamic acid.

In some embodiments, the cobalt complexor is selected from the group consisting of an amino acid having only one acidic moiety, an aminocarboxylic acid, and a phosphonic acid. In a further embodiment, the aminocarboxylic acid is selected from the group consisting of ethylenediaminetetraacetic acid, diethylenetriaminepentaacetic acid, triethylenetetraminehexaacetic acid, and salts thereof. In another embodiment, the phosphonic acid is selected from the group consisting of ethylenediaminetetra(methylenephosphonic acid), diethylenetriaminepenta(methylenephosphonic acid), and salts thereof.

In some embodiments, the oxidizer is a peroxide.

In some embodiments, the abrasive is selected from the group consisting of silica and alumina.

In some embodiments, the slurry has a pH of about 4 to about 9. In some embodiments, the slurry does not contain alanine. In some embodiments, the slurry does not contain a compound having a triazole moiety.

In another aspect of the present disclosure, provided is a method of inhibiting corrosion of a cobalt-containing substrate when undergoing chemical mechanical polishing, comprising incorporating glutamic acid into a CMP slurry as a cobalt corrosion inhibitor.

In another aspect of the present disclosure, provided is a method of inhibiting corrosion of a cobalt-containing substrate when undergoing chemical mechanical polishing, comprising polishing the cobalt-containing substrate with any of the slurries described herein.

In another aspect of the present disclosure, is provided a method of inhibiting corrosion of a cobalt-containing substrate while maintaining a high cobalt removal rate when undergoing chemical mechanical polishing, comprising polishing the cobalt-containing substrate with any of the slurries described herein.

In another aspect of the present disclosure, is provided a method of inhibiting corrosion of a cobalt-containing substrate while maintaining a high cobalt removal rate when undergoing chemical mechanical polishing, comprising incorporating glutamic acid into a CMP slurry as a cobalt corrosion inhibitor and incorporating glycine or a salt thereof as a cobalt complexor. In some embodiments, the cobalt removal rate is 100 Å/minute or more and the corrosion is measured by a static etching rate. In some embodiments, the ratio of cobalt removal rate to static etching rate is greater than 3:1. In a further embodiment, the static etching rate is less than 100 Å/minute.

In another aspect of the present disclosure, is provided a method of polishing a cobalt-containing substrate comprising applying any of the slurries described herein and a polishing pad to a surface of the cobalt-containing substrate and polishing the surface of the substrate.

### DETAILED DESCRIPTION

Provided herein are compositions and related methods and systems for performing chemical mechanical polishing (CMP) of a surface. As used herein, the term “chemical mechanical polishing” or “planarization” refers to a process of planarizing (polishing) a surface with the combination of surface chemical reaction and mechanical abrasion. In some embodiments, the chemical reaction is initiated by applying to the surface a composition (e.g., referred to as a ‘polishing slurry,’ a ‘polishing composition,’ a ‘slurry composition’ or simply a ‘slurry’) capable of reacting with a surface material, thereby turning the surface material into a product that can be more easily removed by simultaneous mechanical abrasion. In some embodiments, the mechanical abrasion is performed by contacting a polishing pad with the surface, and moving the polishing pad relative to the surface.

Composition

The slurries for chemical mechanical polishing disclosed herein can comprise, consist essentially of, or consist of the following components.

In some embodiments, the polishing slurry comprises an aqueous solvent and at least one cobalt corrosion inhibitor. The term “aqueous solvent” as used herein refers to water, or a solvent mixture of water (e.g., >50%) and a water miscible solvent (e.g., <50%). In some embodiments, the polishing slurry also contains chemical ingredients selected specifically for processing a certain type of surface, such as for polishing a cobalt-containing surface, as opposed to a different surface that does not contain a metal (or that contains a different metal). Examples of such chemical ingredients include catalysts, stabilizers, inhibitors, surfactants, oxidants, and others. Each of these ingredients may be selected to improve desired processing, for example efficient removal, of a material from the surface. Additionally, in some embodiments, the slurry also contains abrasive particles or grains to enhance the removal rate by mechanical abrasion in the presence of the slurry. The type of abrasive particles may also be selected based on the type of substrate being processed.

Chemical mechanical polishing (CMP) is an important part of damascene process flow. In some embodiments, a metal material is removed in a single step that uncovers a dielectric surface. In other embodiments, a “two-step” process can be used. In a first step, a large portion of the excess metal is removed but the dielectric layer is not exposed. This step is commonly referred to as a “bulk” removal step during which a high metal removal rate is desired for high throughput. A subsequent (second) step can be used to remove the remaining metal and expose the underlying dielectric and metal surface. This step is sometimes referred to as a “polishing” step, wherein a high metal removal rate may be important, when balanced with other also important performance requirements, such as the tendency of some CMP slurries to cause strong corrosion of the metal surface.

Cobalt Corrosion Inhibitor

Corrosion is a common side-effect of a polishing slurry. During the CMP process, chemical ingredients of the polishing slurry that remain on the metal surface continue to etch the metal, beyond the effects of the CMP. High level of corrosion may contribute to surface defects such as pitting and keyholing. These defects may significantly impair the properties and hamper the usefulness of final products manufactured out of the polished products. In some embodiments, corrosion is measured by visually inspecting a polished surface, with or without a microscope, and determining the percentage of a surface area of interest that has been affected by corrosion during the CMP process (see Example 1).

In some embodiments, the present polishing slurry is suitable for cobalt (Co) removal. In some embodiments, a high Co removal rate is obtained. In some embodiments, a high removal rate is also balanced with the need to prevent a high level of Co corrosion under the harsh conditions under which CMP is performed. In some embodiments, these goals are achieved by performing Co CMP using a polishing slurry that contains a suitable Co cobalt corrosion inhibitor, which on one hand effectively suppresses Co corrosion under the CMP conditions, and on the other hand also permits a high Co removal rate.

In some embodiments, the Co removal rate of a CMP procedure using the present polishing slurry is less than 500 Å/min, or less than 1000 Å/min, or less than 1500 Å/min, or less than 2000 Å/min, or less than 2500 Å/min, or less than 3000 Å/min, or less than 3500 Å/min, or less than 4000 Å/min, or less than 4500 Å/min or less than 5000 Å/min.

A static etch rate (SER) of a slurry can be measured as the rate at which a target metal statically dissolves in a slurry without the aid of mechanical abrasion. Thus statistic etch rate can be indicative of surface protection provided by a cobalt corrosion inhibitor contained in the slurry. In some embodiments, the cobalt corrosion inhibitor functions to maintain a high metal removal rate while keeping the static etch rate low at the same time. In some embodiments, a cobalt coupon is immersed in the slurry at 50° C. for 5 minutes, then the static etch rate is measured as the reduction in the coupon's thickness per unit time. In some embodiments, the static etching rate is less than 100 Å/minute. For example, in some embodiments, the static etch rate of the present slurry is in the range of about 0 to 5 angstrom per minute (A/min). In some embodiments, the static etch rate of a slurry is preferably in the range of about 5 to about 10 Å/min. In some embodiments, the static etch rate of a slurry is preferably in the range of about 10 to about 20 Å/min. In some embodiments, the static etch rate of a slurry is preferably in the range of about 20 to about 30 Å/min. In some embodiments, the static etch rate of a slurry is preferably in the range of about 30 to about 40 Å/min. In some embodiments, the static etch rate of a slurry is preferably in the range of about 40 to about 50 Å/min.

Without being bound by the theory, it is contemplated that a suitable cobalt corrosion inhibitor compound according to the present disclosure comprises at least two reactive groups capable of associating with the metal surface. In some embodiments, the attachment of the reactive groups to the metal surface is achieved through the formation of chemical or physical binding between the reactive group and a metal oxidation product formed on the metal surface, such as Co oxide or Co hydroxide on a Co surface.

In some embodiments, the at least two reactive groups of the cobalt corrosion inhibitor are acidic moieties. The term “acidic moiety” as used herein refers to a chemical moiety that is negatively charged or is capable of supporting a negative charge at the neutral pH or the pH of the environment that the moiety is exposed to. Acidic moieties include but are not limited to carboxylic acid, sulphonic acid, phosphonic acid, and salts thereof, such as carboxylates, sulphonates, sulphates, and phosphonates.

In some embodiments, the present slurry comprises one or more cobalt corrosion inhibitors selected from aspartic acid, glutamic acid, cysteine, carboxyglutamic acid, kainic acid, acromelic acid, domoic acid, alpha-aminoadipic acid, 2-amino-3-carboxymuconic semialdehyde, 2-aminomuconic acid, octopine, opine, N(ε)-carboxymethyllysine, gamma-glutamylcysteine, saccharopine, diaminopimelic acid, cystathionine, cysteinyldopa, nicotianamine, nopaline, N-methyl-D-aspartic acid, lanthionine, formiminoglutamic acid, glutathione, or derivatives or salts thereof. In some embodiments, the present slurry comprises two or more cobalt corrosion inhibitors selected from the group above. In some embodiments, the present slurry comprises one or more cobalt corrosion inhibitors selected from aspartic acid and glutamic acid. In some embodiments, the present slurry the cobalt corrosion inhibitor consists of one or more of the above compounds.

In some embodiments, the present slurry comprises about 0.0001% to about 1% by weight of the cobalt corrosion inhibitor. In some embodiments, the present slurry comprises above about 0.001 wt % of the cobalt corrosion inhibitor. In some embodiments, the present slurry comprises above about 0.005 wt % of the cobalt corrosion inhibitor. In some embodiments, the present slurry comprises above about 0.01 wt % of the cobalt corrosion inhibitor. In some embodiments, the present slurry comprises above about 0.03 wt % of the cobalt corrosion inhibitor. In some embodiments, the present slurry comprises above about 0.05 wt % of the cobalt corrosion inhibitor. In some embodiments, the present slurry comprises above about 0.1 wt % of the cobalt corrosion inhibitor. In some embodiments, the present slurry comprises above about 0.2 wt % of the cobalt corrosion inhibitor. In some embodiments, the present slurry comprises above about 0.3 wt % of the cobalt corrosion inhibitor. In some embodiments, the present slurry comprises above about 0.5 wt % of the cobalt corrosion inhibitor. In some embodiments, the present slurry comprises above about 1.0 wt % of the cobalt corrosion inhibitor.

Complexor

In some embodiments, the present slurry further comprises at least one complexor. As used herein, the term “complexor” refers to a chemical compound that interacts with surfaces of metals to be polished during the CMP process. In some embodiments, the complexor is selected from the group consisting of an amino acid having only one acidic moiety, an aminocarboxylic acid, and a phosphonic acid. Particularly, in some embodiments, the complexor comprises or consists of at least one amino group.

“Å/mino groups” as used herein refer to functional groups that contain a basic nitrogen atom having a lone pair and single bonds to hydrogen atom(s) and/or substituent chemical group(s). The substituent chemical group is not specifically limited, and in various embodiments, can be either an organic or inorganic group, such as a halogen group, an alkyl group, an aromatic group or an acyl group. Å/mines are compounds containing at least one amino group. Particularly, primary amines refer to nitrogen-containing compounds having two hydrogen atoms and one substituent group covalently bonded to the nitrogen. Secondary amines refer to nitrogen-containing compounds having one hydrogen atom and two substituent groups covalently bonded to the nitrogen. Tertiary amines are nitrogen-containing compounds where the nitrogen atom covalently bonded to three substituent groups. Cyclic amines are either secondary or tertiary amines where the nitrogen atom is included in a cyclic structure formed by the substituent groups. Most amino acids are primary amines. Proline is a secondary cyclic amine.

In some embodiments, the complexor further comprises one acidic moiety. In some embodiments, the acidic moiety is a carboxyl group having the general formula —(C(═O)OH). In some embodiments, the carboxyl group serves to enhance chemical interaction between the complexor and the metal to be polished, for example by adsorbing the complexor onto the surface of the metal film.

In some embodiments, the complexor has at least one amino group and at least one carboxyl group connected by a chemical linking structure. As used herein “aminocarboxylic acid” refers to such a complexor. The chemical linking between the at least one carboxyl group and the at least one amino group of the complexor is not specifically limited. In some embodiments, the chemical linking structure between the at least one carboxyl group and the at least one amino group of the complexor can be a linear, branched and/or cyclic carbon chain having 1 to 20 carbon atoms. Optionally, the chemical linking structure comprises unsaturated covalent bonds and heteroatoms, such as nitrogen, oxygen, sulfur, phosphate, and/or halogens. Optionally, the carbon chain comprises one or more substituted or unsubstituted aryls, acyls, esters, alkoxyls, alkyls, carbonyls, hydroxyls, etc. In some embodiments the complexor is an aminocarboxylic acid selected from the group consisting of ethylenediaminetetraacetic acid, diethylenetriaminepentaacetic acid, triethylenetetraminehexaacetic acid, and salts thereof.

In some embodiments, the complexor has a cyclic structure. According to the present disclosure, the cyclic structure may be an aromatic ring or an aliphatic ring. In some embodiments, the cyclic structure may contain a heteroatom. In some embodiments, the cyclic structure may be a condensed ring containing two or more rings. In some embodiments, the heteroatom referred to herein may be selected from the group consisting of a nitrogen atom, an oxygen atom, a sulfur atom, and a phosphorus atom. In various embodiments, the cyclic structure may be branched or unbranched, saturated or unsaturated. The cyclic structure may have 3 to 12 ring members, particularly, 4 to 7 ring members, and more particularly 5 to 6 ring members. Examples of the cyclic structure formed include a benzene ring, a naphthalene ring, a pyridine ring, a pyridazine ring, a pyrimidine ring, a pyrazine ring, a pyrrole ring, a cyclohexadiene ring, a cyclohexene ring, a cyclopentene ring, a cyclopentane ring, a cycloheptatriene ring, a cycloheptadiene ring, a cycloheptene ring, and a cycloheptane ring.

In some embodiments, the complexor is an amino acid or analog thereof. In some embodiments, the amino acid or analog thereof has only one acidic moiety. The amino acid complexors of the present disclosure include but are not limited to α-amino acids, where the amino group is attached to the α-carbon in the carbon backbone connecting the amino group and carboxyl group. For example, in various embodiments, the amino acid complexor can be β-, γ-, δ-amino acids, etc. The amino acid complexors of the present disclosure include but are not limited to the amino acids arginine, histidine, lysine, serine, threonine, asparagine, glutamine, cysteine, selenocysteine, glycine, proline, alanine, isoleucine, leucine, methionine, phenylalanine, tryptophan, tyrosine, valine and derivatives or analogs thereof. In some embodiments, the complexor is glycine or salts thereof. In some embodiments, the amino acid is not alanine.

As used herein, analogs of amino acids include, but are not limited to, amino acid isosteres. In some embodiments, the amino acid isostere comprises a carboxylic acid isostere, an amine isostere, or a combination thereof. In some embodiments, the carboxylic acid group of the amino acid is replaced with a carboxylic acid isostere. Non-limiting examples of carboxylic acid isosteres include sulfonic acids, sulfinic acids, hydroxamic acids, hydroxamic esters, phosphonic acids, phosphinic acids, sulfonamides, acylsulfonamides, sulfonylureas, acylureas, tetramic acids, or cyclopentane-1,3-diones. In some embodiments the carboxylic acid group of the amino acid is replaced with a phosphonic acid. In some embodiments, the amino group of the amino acid is replaced with an amine isostere. Non-limiting examples of amine isosteres include hydroxyl and thiol.

In some embodiments the complexor is a phosphonic acid comprising a moiety having the general formula —P(═O)(OH)₂. In some embodiments the phosphonic acid is selected from the group consisting of ethylenediaminetetra(methylenephosphonic acid), diethylenetriaminepenta(methylenephosphonic acid), and salts thereof.

In some embodiments, the present slurry comprises about 0.1% to about 10% by weight of the complexor. In some embodiments, the present slurry comprises about 0.1% by weight of the complexor. In some embodiments, the present slurry comprises about 0.3% by weight of the complexor. In some embodiments, the present slurry comprises about 0.5% by weight of the complexor. In some embodiments, the present slurry comprises about 1.0% by weight of the complexor. In some embodiments, the present slurry comprises about 2.0% by weight of the complexor. In some embodiments, the present slurry comprises about 3.0% by weight of the complexor. In some embodiments, the present slurry comprises about 5.0% by weight of the complexor. In some embodiments, the present slurry comprises about 10% by weight of the complexor. In some embodiments, the complexor to cobalt corrosion inhibitor ration is greater than 3:1 by weight, e.g., 3:1 to about 20:1. For example, the ratio may be about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1 or about 20:1 by weight (e.g., glycine:glutamic acid ratio).

pH Adjusting Agent

In some embodiments, the present slurry further comprises at least one pH adjusting agent. In some embodiments, the pH of the present slurry is, although not particularly limited, in the range of about 1 to about 13, inclusive of the end points. In some embodiments, the pH of the present slurry is in the range of about 1.5 to about 12.5, inclusive of the end points. In some embodiments, the pH of the present slurry is in the range of about 2 to about 12, inclusive of the end points. In some embodiments, the pH of the present slurry is in the range of about 2.5 to about 11.5, inclusive of the end points. In some embodiments, the pH of the present slurry is in the range of about 3 to about 11, inclusive of the end points. In some embodiments, the pH of the present slurry is in the range of about 3.5 to about 10.5, inclusive of the end points. In some embodiments, the pH of the present slurry is in the range of about 4 to about 10, inclusive of the end points. In some embodiments, the pH of the present slurry is in the range of about 4.5 to about 9.5, inclusive of the end points. In some embodiments, the pH of the present slurry is in the range of about 5 to about 9, inclusive of the end points. In some embodiments, the pH of the present slurry is in the range of about 5.5 to about 8.5, inclusive of the end points. In some embodiments, the pH of the present slurry is in the range of about 6 to about 8, inclusive of the end points.

In some embodiments, an acid or an alkali is used as the pH adjusting agent. The acid or alkali used in connection with the present invention can be organic or inorganic compounds. Examples of the acid include inorganic acids such as sulfuric acid, nitric acid, boric acid, carbonic acid, hypophosphorous acid, phosphorous acid, and phosphoric acid; and organic acids such as carboxylic acids including formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, and lactic acid, and organic sulfuric acids including methanesulfonic acid, ethanesulfonic acid, and isethionic acid. Examples of the alkali include hydroxides of an alkali metal, such as potassium hydroxide; ammonium hydroxide, ethylene diamine, and piperazine; and quaternary ammonium salts such as tetramethyl ammonium hydroxide and tetraethyl ammonium hydroxide. These acids or alkalis can be used either singly or in combination of two or more types.

Content of the acid or alkali in the slurry is not particularly limited as long as it is an amount allowing the slurry to be within the aforementioned pH range.

Abrasive

In some embodiments, the present slurry further comprises at least one abrasive. The abrasive in the polishing slurry provides or enhances mechanical abrasion effects during the CMP process. Examples of abrasives that can be used in connection with the present disclosure include but are not limited to alumina abrasive, silica abrasive, ceria abrasive, titanium oxide, zirconia, or mixtures thereof. The preferred abrasives are alumina and silica. (More preferred is colloidal silica) In order to reduce scratch defects, the mean particle size of the abrasive is preferably controlled. In some embodiments, the lower limit of an average primary particle diameter of the abrasive grains is 5 nm or more, 7 nm or more, 10 nm or more. Furthermore, the upper limit of the average primary particle diameter of the abrasive grains is 300 nm or less, 200 nm or less, 100 nm or less. Within such a range, the polishing rate of the polishing object by the polishing composition is improved, and it is possible to further suppress an occurrence of polishing defect (scratch) on the surface of the polishing object after the polishing object is polished by using the polishing composition. Meanwhile, the average primary particle diameter of the abrasive grains is calculated, for example, based on a specific surface area of the abrasive grains which is measured by a BET method. The upper limit of an average secondary particle diameter of the abrasive grains is 500 nm or less, 400 nm or less, 300 nm or less, 250 nm or less. The average secondary particle diameter value of the abrasive grains can be determined by, for example, the laser light scattering method. The lower limit of the average secondary particle diameter of the abrasive grains is 10 nm or more, 15 nm or more, 20 nm or more.

In some embodiments, the present slurry comprises about 0.01% to about 10% by weight of the abrasive. In some embodiments, the present slurry comprises less than 10% by weight of the abrasive. In some embodiments, the present slurry comprises less than 9% by weight of the abrasive. In some embodiments, the present slurry comprises less than 8% by weight of the abrasive. In some embodiments, the present slurry comprises less than 7% by weight of the abrasive. In some embodiments, the present slurry comprises less than 6% by weight of the abrasive. In some embodiments, the present slurry comprises less than 5% by weight of the abrasive. In some embodiments, the present slurry comprises less than 4% by weight of the abrasive. In some embodiments, the present slurry comprises less than 3% by weight of the abrasive. In some embodiments, the present slurry comprises less than 2% by weight of the abrasive. In some embodiments, the present slurry comprises less than 1% by weight of the abrasive. In some embodiments, the present slurry comprises less than 0.5% by weight of the abrasive. In some embodiments, the present slurry comprises less than 0.2% by weight of the abrasive.

Oxidizer

In some embodiments, the present slurry further comprises at least one oxidizer. As used herein, the term“oxidizer” refers to a chemical compound that oxidizes a metal surface of a polishing object, thereby enhancing the metal removal rate of the CMP process. In some embodiments, an oxidizer is added to the slurry only prior to use. In other embodiments, an oxidizer is mixed with other ingredients of the slurry at approximately the same time during a manufacturing procedure. In some embodiments, the present composition is manufactured and sold as a stock composition, and an end customer can choose to dilute the stock composition as needed and/or add a suitable amount of an oxidizer before using.

Examples of the oxidizer which may be used include, but are not limited to, a peroxide, hydrogen peroxide, sodium peroxide, barium peroxide, an organic oxidizer, ozone water, a silver (II) salt, an iron (III) salt, permanganese acid, chromic acid, dichromic acid, peroxodisulfuric acid, peroxophosphoric acid, peroxosulfuric acid, peroxoboric acid, performic acid, peracetic acid, perbenzoic acid, perphthalic acid, hypochlorous acid, hypobromous acid, hypoiodous acid, chloric acid, chlorous acid, perchloric acid, bromic acid, iodic acid, periodic acid, persulfuric acid, dichloroisocyanuric acid, and a salt thereof. The oxidizer may be used either singly or as a mixture of two or more kinds. Among them, hydrogen peroxide, ammonium persulfate, periodic acid, hypochlorous acid, and sodium dichloroisocyanurate are preferable.

Suitable content of the oxidizer can be determined based on particular needs. For example, the metal removal rate may be expected to increase as the concentration of the oxidizer increases. In some embodiments, content of the oxidizer in the slurry is 0.01% by weight g/L or more. In some embodiments, content of the oxidizer in the slurry is 0.1% by weight or more. In some embodiments, content of the oxidizer in the slurry is 0.3% by weight or more.

In some embodiments, content of the oxidizer in the slurry is 20% by weight or less. In some embodiments, content of the oxidizer in the slurry is 10% by weight or less. In some embodiments, content of the oxidizer in the slurry is 4% by weight or less. As the content of the oxidizer decreases, the cost involved with materials of the slurry can be saved and a load involved with treatment of the slurry after polishing use, that is, a load involved with waste treatment, can be reduced. It is also possible to reduce the possibility of excessive oxidation of a surface by reducing the content of an oxidizer.

Other Components

In some embodiments, for the purpose of enhancing the hydrophilicity of the surface to be polished or increasing the dispersion stability of abrasive, a synthetic water soluble polymer may be added to the present slurry. Examples of the synthetic water soluble polymer include polycarboxylic acids and derivatives thereof (for example, polyacrylic acid, polymethacrylic acid, polyaspartic acid, polyglutamic acid, polylysine, polymalic acid, polymaleic acid, polyitaconic acid, polyfumaric acid, poly(p-styrene carboxylic acid), polyvinyl sulfuric acid, polyaminoacrylamide, polyamic acid, and polyglyoxylic acid), polyethyleneimine, vinyl polymers (for example, polyvinyl alcohol, polyvinyl pyrrolidone, and polyacrolein), and polyglycols (for example, polyethylene glycol, polypropylene glycol, and polytetramethylene glycol). The synthetic water soluble polymer may be used either alone or as a mixture of two or more kinds.

In some embodiments, the slurry according to the present disclosure also comprises at least one surfactant. Without being bound by the theory, it is contemplated that surfactants can improve surface smoothness of polished metal film and reduce defects. Surfactants can also improve the within-wafer uniformity of removal rate. Non-ionic, anionic, cationic, and Zwitterionic surfactants can all be used. Exemplary surfactants that can be used in connection with the present disclosure include but are not limited to polyethylene glycol sorbitan monolaurate and other polyoxyethylene derivatives of sorbitan esters under trade name “Tween” from Uniqema; polyethylene glycol octadecyl ether and other polyoxyethylene fatty ether under trade name “Brij” from Uniqema; nonylphenol ethoxylates under trade name Tergitol from Dow Chemical; octylphenol ethoxylates under trade name Triton X from Dow Chemical; sodium lauryl sulfate and other surfactants of salts of alkyl sulfate; sodium 1-dodecanesulfonate and other surfactants of salts of alkyl sulfonate; quaternary ammonium salts. The surfactant concentration presented in the CMP slurry of this disclosure can be in a range from 0 to 1% by weight and preferably from 0.01 to 0.2% by weight. These surfactants may be used either alone or in mixture of two or more kinds thereof.

In some embodiments, the slurry according to the present disclosure may also comprise a biocide or other preservatives. Examples of preservatives and biocides that may be used in connection with the present invention include an isothiazoline-based preservative such as 2-methyl-4-isothiazolin-3-one or 5-chloro-2-methyl-4-isothiazolin-3-one, paraoxybenzoate esters, and phenoxyethanol, and the like. These preservatives and biocides may be used either alone or in mixture of two or more kinds thereof.

In some embodiments, the slurry according to the present disclosure does not include certain components. For example, in some embodiments, the slurry does not contain azole-containing inhibitors. In some embodiments, the slurry does not contain alanine. IN some embodiments, the slurry does not contain azole compounds such as pyrazole compound (for example, 1H-pyrazole, or their derivatives), imidazole compound (for example, 1H-imidazole, 1H-benzoimidazole, or their derivatives), triazole compound (for example, 1H-triazole, 1H-benzotriazole, or their derivatives), tetrazole compound (for example, 1H-tetrazole, or their derivatives). indazole compound (for example, 1H-indazole, or their derivatives), polysaccharides (for example, alginic acid, pectic acid, carboxymethylcellulose, agar, xanthan gum, chitosan, methyl glycol chitosan, methylcellulose, ethylcellulose, hydroxymethyl cellulose, hydroxyethyl cellulose, hydroxypropylcellulose, hydroxypropyl methylcellulose, carboxymethylcellulose, carboxyethylcellulose, and pullulan).

Methods and Compositions

In another aspect of the present disclosure, provided herein are methods for chemical mechanical polishing (CMP) of an object having at least one metal surface. The method comprises contacting the metal surface with a polishing pad; delivering a polishing slurry according to the present disclosure to the metal surface; and polishing said metal surface with the polishing slurry.

In another aspect of the present disclosure, provided herein are methods for preventing metal corrosion during a chemical mechanical polishing (CMP) process. The method comprises using for the CMP a slurry according to the present disclosure.

In another aspect of the present disclosure, provided herein are systems for chemical mechanical polishing (CMP). The system comprises a substrate comprising at least one metal surface, a polishing pad, and a polishing slurry according to the present disclosure.

In yet another aspect of the present disclosure, provided herein is a substrate comprising at least one metal surface, wherein the substrate is in contact with a chemical mechanical polishing (CMP) slurry according to the present disclosure.

In some embodiments, the present methods and compositions are suitable for polishing a Co surface. An apparatus or conditions commonly used for Co polishing can be adopted and modified according to particular needs. The selections of a suitable apparatus and/or conditions for carrying out the present methods are within the knowledge of a skilled artisan.

In another aspect of the present disclosure, provided is a method of inhibiting corrosion of a cobalt-containing substrate when undergoing chemical mechanical polishing, comprising incorporating glutamic acid into a CMP slurry as a cobalt corrosion inhibitor.

In another aspect of the present disclosure, provided is a method of inhibiting corrosion of a cobalt-containing substrate when undergoing chemical mechanical polishing, comprising polishing the cobalt-containing substrate with any of the slurries described herein.

In another aspect of the present disclosure, is provided a method of inhibiting corrosion of a cobalt-containing substrate while maintaining a high cobalt removal rate when undergoing chemical mechanical polishing, comprising polishing the cobalt-containing substrate with any of the slurries described herein.

In another aspect of the present disclosure, is provided a method of inhibiting corrosion of a cobalt-containing substrate while maintaining a high cobalt removal rate when undergoing chemical mechanical polishing, comprising incorporating glutamic acid into a CMP slurry as a cobalt corrosion inhibitor and incorporating glycine or a salt thereof as a cobalt complexor. In some embodiments, the cobalt removal rate is 100 Å/minute or more and the corrosion is measured by a static etching rate. In some embodiments, the ratio of cobalt removal rate to static etching rate is greater than 3:1. In a further embodiment, the static etching rate is less than 100 Å/minute.

In another aspect of the present disclosure, is provided a method of polishing a cobalt-containing substrate comprising applying any of the slurries described herein and a polishing pad to a surface of the cobalt-containing substrate and polishing the surface of the substrate.

In some embodiments, the present methods and compositions provide a corrosion grade of the polished surface of grade 3 or above, according to Table 1. In some embodiments, the present methods and compositions provide a corrosion grade of the polished surface of grade 5. In some embodiments, the present methods and compositions provide a Co removal rate of that is greater than 500 Å/min, or greater than 1000 Å/min, or greater than 1500 Å/min, or greater than 2000 Å/min, or greater than 2500 Å/min, or greater than 3000 Å/min. In some embodiments, the slurry of the present methods and compositions produces a Co static etch rate in the range of about 0 to 5 Å/min, or about 5 to about 10 Å/min, or about 10 to about 20 Å/min, or about 20 to about 30 Å/min, or about 30 to about 40 Å/min, or about 40 to about 50 Å/min at 50° C.

### EXAMPLES

### Example 1: Establishment of a Corrosion Grade System for Evaluating the Corrosion Performance of a Slurry

In order to systematically evaluate and compare corrosion performances of candidate slurries, a corrosion grade system is developed as shown in Table 1. Accordingly, for example, a corrosion grade of 1 or above indicates that corrosion on the surface of interest is easily visible to the naked eye of a human inspector, and microscopic inspection using a 10 times (10×) magnification shows that the corrosion affects less than 75% surface area of the surface of interest. For example, a corrosion grade of 4.3 indicates that no corrosion on the surface of interest can be observed with the naked eye of a human inspector, and microscopic inspection using a 10 times (10×) magnification shows that the corrosion affects less than 0.05% surface area of the surface of interest.

TABLE 1
Corrosion grades

| Grade | Description |
|---|---|
| 1 | Corrosion of the surface of interest easily visible with the naked |
| | eye. Microscope shows corrosion, affecting <75% surface area |
| | of the surface of interest. |
| 2 | Corrosion of the surface of interest visible with the naked eye, |
| | and multiple corrosion sizes can be observed. Microscope shows |
| | corrosion, affecting <10% surface area of the surface of interest. |
| 3 | Corrosion of the surface of interest not visible to the naked eye. |
| | Microscope shows corrosion, affecting <1% surface area of the |
| | surface of interest. |
| 4 | Corrosion of the surface of interest not visible with the naked |
| | eye. Microscope shows pitting corrosion, affecting <0.05% |
| | surface area of the surface of interest. |
| 5 | Very clean, mirror-like surface of interest with no corrosion |
| | observable with the naked eye. Microscope proves no corrosion |
| | on the surface of interest. |

Acceptable ranges of corrosion grade depend on the particular CMP process and/or requirements of a particular product or manufacturing process, which can be determined with the common skill of the art. In some embodiments, a CMP product having a corrosion grade of 3 or above is considered acceptable.

### Example 2: Optimization of Co Removal Rate and Corrosion Performance During Chemical Mechanical Polishing (CMP)

Slurries A, B, C, D, I, E, F, H, M, J and L, whose compositions and pHs are presented in Table 2 with colloidal silica's primary particle size is 35 nm and the secondary particle size is 65 nm, were tested on cobalt prepared via physical vapor deposition (PVD Co) to determine the i) Co removal rate (RR), ii) Co static etching rate (SER), and iii) Co corrosion grade (CG), when each respective slurry is used for CMP of the PVD Co. Each slurry was diluted 3.2× with 0.68 wt % hydrogen peroxide.

Particularly, a Co wafer was immersed within the slurry for 5 minutes at 50° C., and the reduction in the thickness of the Co coupon was measured for calculating the static etch rate. Further, the surface of the Co coupon was inspected for corrosion both by the naked eye of a human inspector and with a microscope at 10 times (10×) magnification. Co removal rates were measured. TECHPREP benchtop polisher from Allied High Tech Products, Inc., was used. Platen speed was 150 rpm while head downforce was fixed at 1.06 psi. Head speed was 150 pm. The slurry flow rate was 50 mL/min. Cobalt wafer coupons (1.5″×1.5″) were used. Polishing time was 20 sec. Co RR was measured on Resmap (ResMap 273 from Creative Design Engineering, Inc.). The results are tabulated in Table 3.

TABLE 2
Slurry compositions and pH

| | Slurry | | | | | | | | | | |
|---|---|---|---|---|---|---|---|---|---|---|---|
| | A | B | C | D | I | E | F | H | M | J | L |
| pH | 6.2 | 4.2 | 6.5 | 8.5 | 9.5 | 6.5 | 6.5 | 6.5 | 6.5 | 6.5 | 6.5 |
| Silica (wt %) | 0.7 | 0.7 | 0.7 | 0.7 | 0.7 | 0.7 | 0.7 | 0.7 | 0.7 | 0.7 | 0.7 |
| KOH (wt %) | 0.01 | 0.01 | 0.17 | 0.41 | 1.17 | 0.01 | 0.01 | 0.01 | 0.01 | 0.01 | 0.01 |
| Glycine (wt %) | 3.65 | 3.65 | 3.65 | 3.65 | 3.65 | 3.65 | 3.65 | 3.65 | 3.65 | 3.65 | 3.65 |
| Lauric acid | 0.0037 | 0.0037 | 0.0037 | 0.0037 | 0.0037 | 0.0037 | — | — | — | — | — |
| salt (wt %) | | | | | | | | | | | |
| L-glutamic | — | 0.29 | 0.29 | 0.29 | 0.29 | 0.022 | 0.022 | — | — | — | — |
| acid (wt %) | | | | | | | | | | | |
| Alanine (wt %) | — | — | — | — | — | | | 1.22 | 2.53 | — | — |
| BTA (wt %) | — | — | — | — | — | | | — | — | 0.0037 | 0.01 |

TABLE 3
Experimental results (RR and SER are given in units Å/min)

| | Slurry | | | | | | | | | | |
|---|---|---|---|---|---|---|---|---|---|---|---|
| | A | B | C | D | I | E | F | H | M | J | L |
| RR | 1423 | 974 | 1100 | 136 | 90 | 854 | 1589 | 2044 | 3352 | 1790 | 1511 |
| SER | 115 | 37 | 30 | 37 | 18 | 26 | 28 | 910 | 822 | 906 | 806 |
| CG | 2 | 5 | 5 | 5 | 4 | 5 | 5 | 2 | 3 | 2 | 2 |

Referring to Table 3, Slurry A produced a Co RR of 1423 Å/min, a Co SER of 115 Å/min, and a CG of 2. Slurry B produced a Co RR of 974 Å/min, a Co SER of 37 Å/min, and a CG of 5. Slurry C produced a Co RR of 1100 Å/min, a Co SER of 30 Å/min, and a CG of 5. Slurry D produced a Co RR of 136 Å/min, a Co SER of 37 Å/min, and a CG of 5. Slurry I produced a Co RR of 90 Å/min, a Co SER of 118 Å/min, and a CG of 4. Slurry E produced a Co RR of 854 Å/min, a Co SER of 26 Å/min, and a CG of 5. Slurry F produced a Co RR of 1589 Å/min, a Co SER of 28 Å/min, and a CG of 5. Slurry H produced a Co RR of 2044 Å/min, a Co SER of 910 Å/min, and a CG of 2. Slurry M produced a Co RR of 3352 Å/min, a Co SER of 822 Å/min, and a CG of 3. Slurry J produced a Co RR of 1790 Å/min, a Co SER of 906 Å/min, and a CG of 2. Slurry L produced a Co RR of 1511 Å/min, a Co SER of 806 Å/min, and a CG of 2.

Slurry A containing only lauric acid salt as a corrosion inhibitor and a pH of 6.2 provided poor corrosion protection and exhibited pitting corrosion during polishing at RT and static etch testing at 50° C. for 5 min. Slurry C with L-glutamic acid produced good corrosion protection at pH 6.6 and comparable Co RR to that of slurry A. At pH 4.2 (slurry B), an excellent Co RR was observed and at pH 8.5 (slurry D) Co RR was greatly reduced. Moreover, the static etch rates (SER) for slurries B, C and D (containing L-glutamic acid) were very low compared to slurry A which lacks L-glutamic acid.

Corrosion grades were collected after static etch tests at 50° C. for 5 min. Since the formulations already contained too much salt, the concentration of L-glutamic acid was kept low in the slurries. Table 2 shows the formulations of slurries E and F, both at pH 6.5 with 0.022 wt % of L-glutamic acid (10× less L-glutamic acid than the other L-glutamic acid containing slurries). Slurries E and F, both having pH 6.5, produced high Co RR comparable to that of slurry C (also at pH 6.5) despite having 10× less L-glutamic acid. Slurries E and F also maintained excellent corrosion grades and static etch rates. Comparing slurries E and F against each other, slurry F, which lacks lauric acid, generated similar Co RR, corrosion performance and static etch rates to slurry E which contains lauric acid.

Slurries containing L-glutamic acid in a pH range between pH 4 and pH 9 with various L-glutamic acid concentrations are used in this Example. The slurries containing L-glutamic acid revealed great corrosion performance even in low pH ranges while maintaining high Co RR and low static etch rates. With L-glutamic acid present in slurry, no additional cobalt corrosion inhibitor (lauric acid) was necessary for the slurry to have favorable RR, SER and CG. This evident from the results for slurry F, which lacks lauric acid yet maintains favorable properties. Example 2 shows that L-glutamic acid is an additive that protects Co surface from corrosion while maintaining Co RR and low static etch rates.

Data of slurry A compared to B, C, D, I, C, E and F shows that use of lauric acid salt only instead of L-glutamic acid as a cobalt corrosion inhibitor results in poor corrosion performance. Slurry A exhibited pitting corrosion. Slurry I has a higher KOH concentration (and thus pH) vs slurry D, otherwise the components of the slurries are the same. The results for slurries I and D show that increased pH (I) results in lower Co RR. Looking at slurries H and M, which attempt to use alanine as a cobalt corrosion inhibitor, these slurries displayed the highest Co RR but suffered from high SER and a low Co CG. Thus, alanine is a poor cobalt corrosion inhibitor. Slurries J and L incorporate benzotriazole (BTA) as a cobalt corrosion inhibitor. J and L also display high SER along with low CG. Thus, BTA cannot be used as an effective cobalt corrosion inhibitor.

### EQUIVALENTS

The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

All numerical designations, e.g., pH, temperature, time, concentration, amounts, and molecular weight, including ranges, are approximations which are varied (+) or (−) by 10%, 1%, or 0.1%, as appropriate. It is to be understood, although not always explicitly stated, that all numerical designations may be preceded by the term “about.” As used herein, the term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term. It is also to be understood, although not always explicitly stated, that the reagents described herein are merely exemplary and that equivalents of such are known in the art.

All patents, patent applications, provisional applications, and publications referred to or cited herein are incorporated by reference in their entirety, including all figures and tables, to the extent they are not inconsistent with the explicit teachings of this specification.

What is claimed is:

1. A slurry for chemical mechanical polishing of a cobalt-containing substrate, comprising a complexor, an oxidizer, an abrasive and a cobalt corrosion inhibitor,
wherein the cobalt corrosion inhibitor comprises an amino acid having at least two acidic moieties.

2. The slurry of claim 1, wherein the cobalt corrosion inhibitor is selected from aspartic acid, glutamic acid, L-glutamic acid, cysteine, carboxyglutamic acid, kainic acid, acromelic acid, domoic acid, alpha-aminoadipic acid, 2-amino-3-carboxymuconic semialdehyde, 2-aminomuconic acid, octopine, opine, N(ε)-carboxymethyllysine, gamma-glutamylcysteine, saccharopine, diaminopimelic acid, cystathionine, cysteinyldopa, nicotianamine, nopaline, N-methyl-D-aspartic acid, lanthionine, formiminoglutamic acid, glutathione, or derivatives or salts thereof.

3. The slurry of claim 1, wherein the cobalt corrosion inhibitor is selected from aspartic acid and glutamic acid.

4. The slurry of claim 1, wherein the cobalt complexor is selected from the group consisting of an amino acid having only one acidic moiety, an aminocarboxylic acid, and a phosphonic acid.

5. The slurry of claim 4, wherein the aminocarboxylic acid is selected from the group consisting of ethylenediaminetetraacetic acid, diethylenetriaminepentaacetic acid, triethylenetetraminehexaacetic acid, and salts thereof.

6. The slurry of claim 4, wherein the phosphonic acid is selected from the group consisting of ethylenediaminetetra(methylenephosphonic acid), diethylenetriaminepenta(methylenephosphonic acid), and salts thereof.

7. The slurry of claim 1, wherein the oxidizer is a peroxide.

8. The slurry of claim 1, wherein the abrasive is selected from the group consisting of silica and alumina.

9. The slurry of claim 1, wherein the slurry has a pH of about 4 to about 9.

10. The slurry of claim 1, wherein the slurry does not contain alanine.

11. The slurry of claim 1, wherein the slurry does not contain a compound having a triazole moiety.

12. A method of inhibiting corrosion of a cobalt-containing substrate when undergoing chemical mechanical polishing, comprising incorporating glutamic acid into a CMP slurry as a cobalt corrosion inhibitor.

13. A method of inhibiting corrosion of a cobalt-containing substrate when undergoing chemical mechanical polishing, comprising polishing the cobalt-containing substrate with a slurry according to claim 1.

14. A method of inhibiting corrosion of a cobalt-containing substrate while maintaining a high cobalt removal rate when undergoing chemical mechanical polishing, comprising polishing the cobalt-containing substrate with a slurry according to claim 1.

15. A method of inhibiting corrosion of a cobalt-containing substrate while maintaining a high cobalt removal rate when undergoing chemical mechanical polishing, comprising incorporating glutamic acid into a CMP slurry as a cobalt corrosion inhibitor and incorporating glycine or a salt thereof as a cobalt complexor.

16. The method of claim 15, wherein the cobalt removal rate is 100 Å/minute or more and the corrosion is measured by a static etching rate.

17. The method of claim 16, wherein the ratio of cobalt removal rate to static etching rate is greater than 3:1.

18. The method of claim 17, wherein the static etching rate is less than 100 Å/minute.

19. A method of polishing a cobalt-containing substrate comprising applying slurry according to claim 1 and a polishing pad to a surface of the cobalt-containing substrate and polishing the surface of the substrate.
